(19) United States
(12) Patent Application Publication
(10) Pub. No.: US 2010/0320710 A1
(43) Pub. Date: Dec. 23, 2010

(54) Hand dolly for transportation of scuba diving apparatus

(76) Inventor: Larry Edgar Dufour, Ashburnham, MA (US)

Correspondence Address: Larry E. Dufour;DBA A.L.L. Welding, 25 Stowell Road, Ashburnham, MA, 01430, US

(21) Appl. No.: 12/456,671

(22) Filed: Jun. 19, 2009

(51) Int. Cl. B62B 1/00

(52) U.S. Cl. 280/47.24

(57) ABSTRACT

A two wheeled cart that is specifically designed, but not limited to the transportation of two scuba tanks of any size, banded together or singularly, side by side with other scuba gear. It has large wheels and a metal tubular cradle with a metal platform that is elevated from the ground as to protect said scuba equipment during transport. It is compact and light in weight with a self storing handle.

### CROSS-REFERENCE TO RELATED APPLICATIONS

“Not Applicable”

### STATEMENT REGARDING FEDERALLY SPONSORED RESEARCH AND DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention relates to the transportation of amphibious scuba diving apparatus over land, pavement and docks. Conventional carts do not provide for the requirements specific to securing and transporting this apparatus, more specifically scuba air tanks, over the various terrains that may be encountered while gaining access to the shoreline, and this design will address some of the issues. The lower platforms and smaller wheels of conventional carts, or dollies, do not provide the necessary clearance, and also do not adapt well to transporting the equipment with the apparatus secured, in a motor vehicle.

### BRIEF SUMMARY OF THE INVENTION

This design of this invention is small, light in weight, and it will fit in the trunk of most automobiles. It features a raised platform and larger wheels that provide the necessary clearance for rough terrain, and it also features an adjustable, self-storing handle for optimum comfort and ease of use. The dolly will accommodate one or two air tanks, with or without manifolds attached, either separate, or banded together. A removable front shelf bracket provides for an area to attached and carry additional equipment and/or supplies, such as a gear bag.

The tanks are loaded from the front, resting on the platform and against the pads, and will be cradled by the main structural supporting component. A strap system attached to the two strap brackets on the front will secure the tanks in place during transportation. The rest bracket handle serves three purposes. It can be used as a handle to lift the dolly, and also as a rest if it is desired to have the dolly in the horizontal position. It also will help to prevent damage to the apparatus if the dolly were to fall over.

### BRIEF DESCRIPTION OF THE SEVERAL VIEWS OF THE DRAWING

FIG. 1) An exploded view with numbered parts and the assembly in the center

FIG. 2) A left front view of the dolly with the handle extended

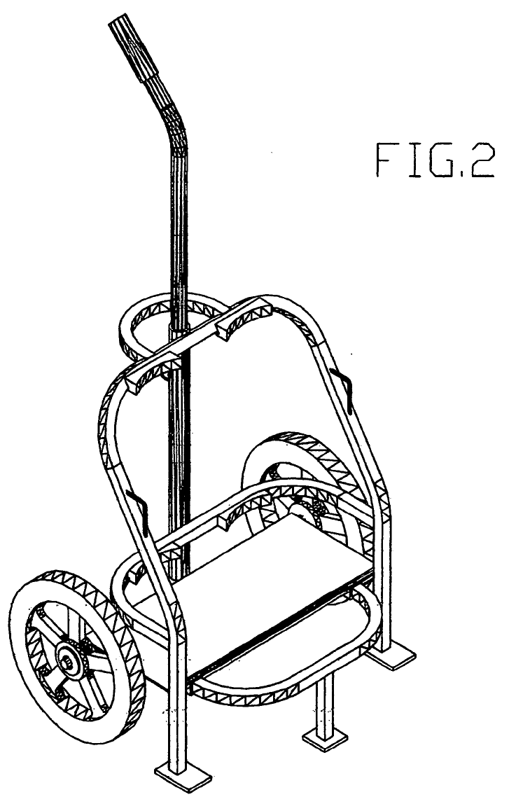

FIG. 3) A left front view of the dolly with the handle retracted

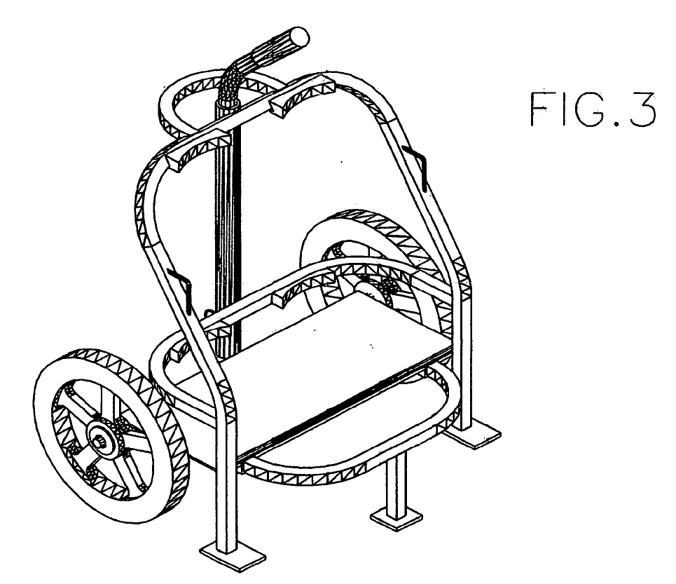

FIG. 4) A view of the dolly from the bottom left

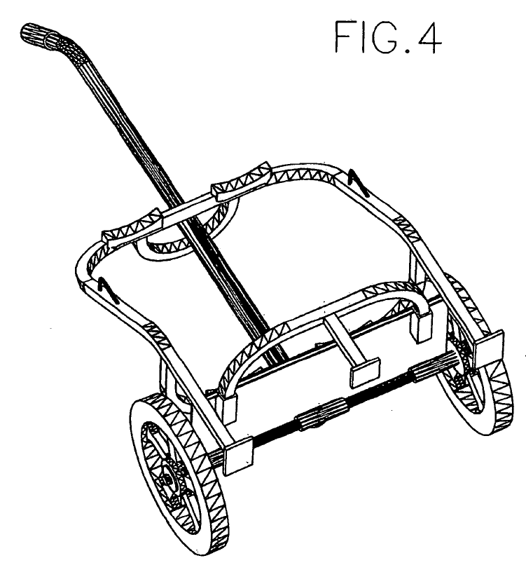

FIG. 5) A view of the dolly with the shelf bracket detached

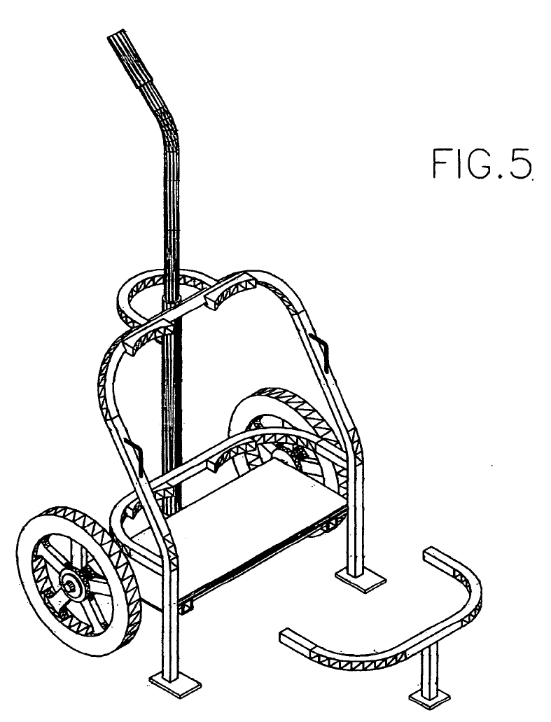

FIG. 6) A view of the dolly without the shelf bracket

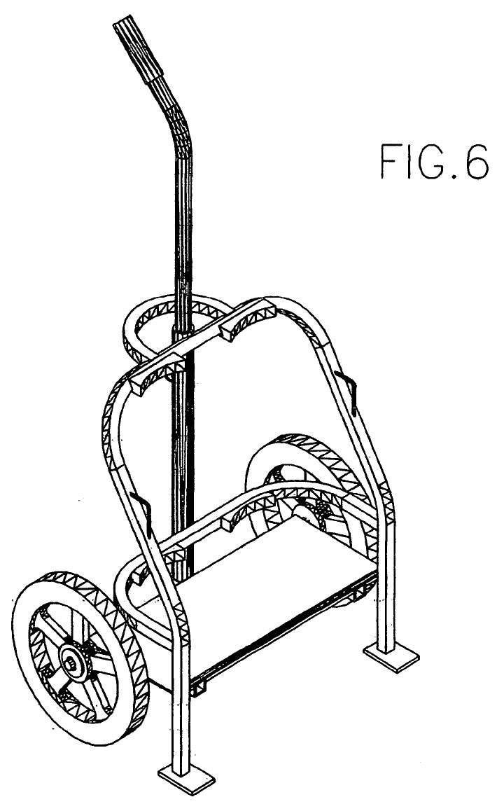

FIG. 7) A right rear view of the dolly with the handle extended

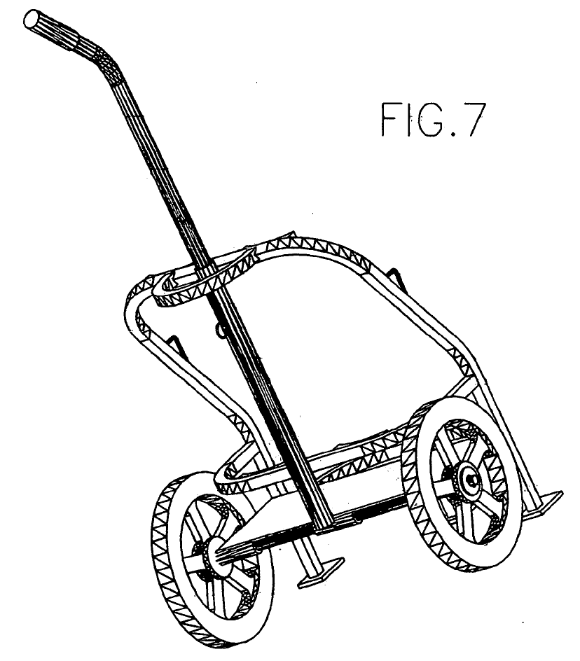

FIG. 8) A view of the removable shelf bracket

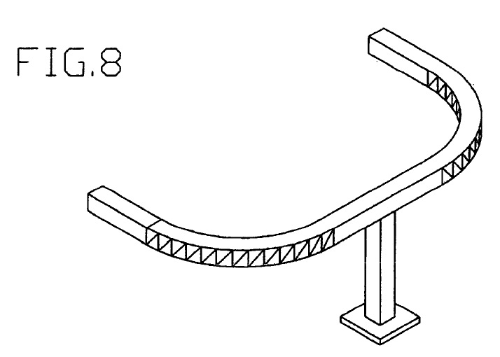

FIG. 9) A view of the wheel and axle assembly

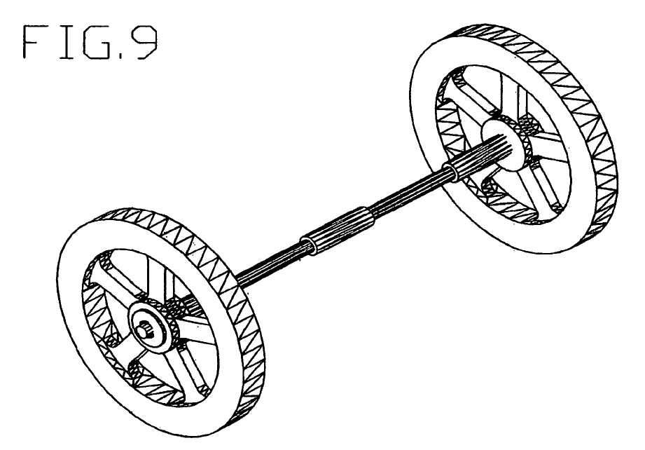

### DETAILED DESCRIPTION OF THE INVENTION

The dolly will be as shown in the attached drawings, and can be manufactured using steel, stainless steel, or aluminum, and of welded construction.

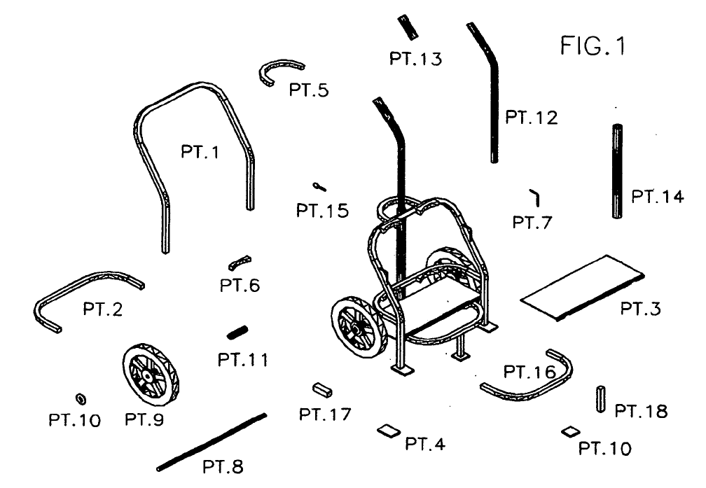

The frame will consist of square or round hollow tubing, with a sheet metal platform. The main structural supporting component (FIG. 1—Pt. 1) will be formed from a single piece of tubing with two straight sections extending up from the platform to two 33° bends extending at this angle to two 90° bends at opposite corners of the top rail. The lower saddle (FIG. 1—Pt. 2), will be formed from a single piece of the same tubing with two 90°E bends. The lower saddle will match the width of the top rail of the main structural supporting component, and it will be attached to the vertical sections of the main structural component. The platform (FIG. 1—Pt. 3) will be manufactured from a single piece of sheet metal, with a short 90° bend to form the front lip. At the bottom of the front legs of the main structural supporting component will be foot pads (FIG. 1—Pt. 4) constructed of sheet metal of a minimum size of 2″×2″ to aid in preventing the front legs from sinking into a soft ground surface while the dolly is at rest.

At the rear of the main structural supporting component will be the rest bracket handle (FIG. 1—Pt. 5). This will be formed to a full radius from the same hollow tubing as the main structural supporting component and rear saddle. There will be four rubber pads (FIG. 1—Pt. 6) attached to the inside of the main structural supporting component and lower saddle to provide cushions for the air tanks, and to prevent them from shifting position while being transported. On the front of the sloping portion of the structural supporting component will be two strap brackets formed from solid round bar (FIG. 1—Pt. 7). The strap can be any commercially available strap of nylon or similar material, with Velcro and/or quick connect features.

The wheel assembly will consist of two commercially available inflatable or solid rubber wheels (FIG. 1—Pt. 9) attached to a solid round axle (FIG. 1—Pt. 8) with a washer, and cotter pins (FIG. 1—Pt. 10). Push nuts may be used as an alternative attachment method. The axle will be attached to the bottom of the platform with three pieces of hollow round tubing (FIG. 1—Pt. 11) with an inside diameter that is slightly larger than the axle diameter, one in the center and one at each end.

The handle (FIG. 1—Pt. 12) will consist of a piece of hollow round tubing formed with a 45° bend at the top. It will have a rubber handle grip (FIG. 1—Pt. 13), and the handle will be drilled at several locations along the length to allow for adjustment. The handle will be inserted in the handle tube manufactured from hollow round tubing (FIG. 1—Pt. 14) with a slip fit, snug, but not tight, and this part will also will be drilled at several locations along the length to allow for adjustment. There will be one hole drilled near the bottom of both parts to locate the handle in the closed, or storage position. Adjustments will be made using a commercially available locking pin (FIG. 1—Pt. 15) to set the position of the handle. The diameter of the pin will be slightly less than the diameter of the holes in the tube and handle to provide a snug, but not too tight fit, and long enough to pass completely though the handle tube.

The removable shelf bracket (FIG. 1—Pt. 16) will be similar to, and of the same hollow tubing material as the rear saddle, with two 90° bends, but the width will be less so that it can be mounted in the two shelf bracket supports (FIG. 1—Pt. 17), also manufactured of hollow tubing. This tubing will be large enough to provide a snug fit to hold the bracket in place, and the two supports will be attached to the bottom of the platform. The shelf leg (FIG. 1—Pt. 18) will be a straight piece of the same hollow tubing as the removable shelf bracket, and will have a foot pad constructed of sheet metal, 2″×2″.

The dolly is of all welded construction, with the exception of the wheels, washers, cotter pins, rubber pads, and handle. It will be protected from the elements with a corrosion resistant paint, or a powder coating application.

1) A two-wheeled dolly for the transportation of amphibious scuba-diving apparatus. It is to be manufactured using hollow tubing and all welded construction that will provide for a strong and durable assembly that can withstand any forces it may encounter during use. It will be light in weight, with a unique raised platform and cradle design.

2) The two-wheeled scuba dolly will have a rest bracket handle that aids in lifting the dolly over obstacles with the diving apparatus in place. It will also aid in preventing damage to the apparatus if the dolly were to fall over.

3) The two-wheeled scuba dolly will have large foot pads of a minimum size of 2″×2″ that will prevent the dolly from sinking into the beach or any other soft terrain encountered.
